(19) United States
(12) Patent Application Publication
(10) Pub. No.: US 2010/0326586 A1
(43) Pub. Date: Dec. 30, 2010

(54) Device, Use of the Device and Method for Torsional Ultrasonic Welding

(75) Inventor: Hartmut Moeglich, Ettlingen (DE)

Correspondence Address: SHOEMAKER AND MATTARE, LTD, 10 POST OFFICE ROAD - SUITE 100, SILVER SPRING, MD, 20910, US

(73) Assignee: Telsonic Holding AG, Bronschhofen (CH)

(21) Appl. No.: 12/819,783

(22) Filed: Jun. 21, 2010

(30) Foreign Application Priority Data
Jun. 30, 2009 (EP) 09164112.6

(51) Int. Cl. B29C 65/08

(52) U.S. Cl. 156/73.3; 156/580.2

(57) ABSTRACT

A device for torsional ultrasonic welding for joining two parts (4, 5) includes control means (7) for setting method parameters for the ultrasonic welding process, with the aid of which a sonotrode (2) can be activated in such a way that, after completion of the ultrasonic welding process, a first part (4), consisting at least partially of a film of plastic, is joined to a second part (5) detachably to allow it to be torn away.

The invention relates to a device for torsional ultrasonic welding according to the preamble of claim 1. The invention also relates to the use of the device and to a method for torsional ultrasonic welding.

For packaging a product or item to be packaged, use is often made of packages in which a container is closed by a film or a thermoformed or injection-moulded lid. In this case it is often desirable that the film or the lid can be removed from the container again without exerting any great force.

Packages of this type with peelable films and corresponding devices and methods for joining films to containers have been known and customary for some time. For example, an easy-to-open package with a lid is described in DE 36 13 155 A1. For easy opening, the lid is configured as a composite film which has a sealing layer and an adhesion-promoter layer.

DE 103 59 035 A1 discloses a container with a tear-away or tear-off lid, the lid being welded to the rim of the container by means of a peel layer. The term “peel layer” is understood as meaning a layer of plastic (for example of PP, PET, PE or PS) of a lower temperature resistance or melting point than that of the pure polymer material. This can be achieved by appropriate additives. Ultrasonic welding is mentioned in DE 103 59 035 A1 as the welding method. For detachably joining two parts, ultrasonic welding systems with axially excitable sonotrodes, which act perpendicularly on the parts to be welded (longitudinal vibrators), are used. It has been found in practice that packages welded in this way may have unfavourable, and in particular irregular, peeling properties. A further disadvantage is that the welding process is relatively difficult to control. Moreover, the known ultrasonic welding methods are often not suitable for processing very thin films.

It is therefore an object of the present invention to avoid the disadvantages of the known art and, in particular, to provide a device and method of the type stated at the beginning with which a welded product with advantageous handling, in particular allowing regular tearing-off that can be controlled well, can be produced in a simple manner. It is also intended that a welding attachment or welding together of very thin-walled parts should be possible with the device and the method. Moreover, the joining should be performed at lowest possible cost.

These and other objects are achieved according to the invention by a device, use of the device and a method according to the features of the independent claims.

The device according to the invention for torsional ultrasonic welding for joining two parts comprises a sonotrode, which can be induced to undergo torsional ultrasonic vibrations, and an anvil. Such components are known in various configurations to a person skilled in the art. What is novel over the prior art, however, is that the device has control means which are in operative connection with the sonotrode in such a way that the method parameters for the ultrasonic welding process can be set more specifically; and that, after completion of the ultrasonic welding process, a first part, consisting at least partially of a film and/or of plastic, is joined to a second part detachably to allow it to be torn away. Consequently, a welded product with advantageous handling can be produced with this device. “Detachable” is understood here as meaning being joined in such a way that—by contrast with being undetachably joined—nondestructive, or virtually nondestructive, detachment can be achieved with little expenditure of force, typically by simply pulling on a closure with one hand.

The device may be configured in such a way that a (welded) joint can be produced with it which, though weak, is strong enough for provisional securement. Alternatively or in addition, a welding arrangement made up of a multiplicity of welded points is conceivable. Such welding at discrete points can be achieved by operating in a manner specifically designed for the purpose and/or by a corresponding configuration of the sonotrode.

The device is suitable in particular for processing (for example thermoformed) films and injection-moulded plastic containers with special coatings, which are known to a person skilled in the art by the terms “peel layer” and “sealing layer”. For example, films which are known for example by the product name Sure-Peel™ (and many more besides) can be processed with the device. The sealing layer may be activated by subjecting it to ultrasonic vibrations, so that welding or surface bonding (adhesion) takes place.

The device according to the invention opens up a new application area for torsional ultrasonic welding. The use of torsional vibrations leads to unexpectedly uniform tearing-off behaviour.

Various types of films can be processed with this device. Films of plastic, laminates or metal foils with the aforementioned coatings come into consideration for the first part. The second part may also be a film. It goes without saying that the first and/or the second part may, however, also be a comparatively rigid (for example injection-moulded or thermoformed) shaped body, for example a container (for example a yoghurt pot) or a housing.

A further aspect of the invention concerns the use of a device for torsional ultrasonic welding, and in particular a device of the aforementioned type for producing detachable joints between two parts.

The first part and/or the second part may be provided at least in certain portions with a peelable surface coating or intermediate layer, in particular with a peel layer or a sealing layer, before the ultrasonic welding process.

The peelable surface coating or intermediate layer of the first part and/or of the second part may in this case have cohesive peeling properties. Films or parts of this type are very well known to a person skilled in the art by the term “cohesive peel”. Alternatively, however, parts with so-called burst-peel properties or break-peel properties also come into consideration. In the aforementioned DE 36 13 155 A1 there is a description of a joining arrangement which has burst-peel properties that is created by a conventional method.

An advantageous use is obtained by the fact that very thin materials can be processed with the device.

Furthermore, it is possible with this device to weld sensitive parts or critical material combinations, such as for instance coated or painted AL circuit boards or deep-drawn aluminium cups.

It can be ensured by the introduction of torsional energy that, for example, the sealing layer is exposed to less axial loading. As a result, less material of the sealing layer is driven out of the welding region, so that a more uniform remaining layer thickness is present after the welding. A further advantage of torsional ultrasonic welding is therefore uniform peeling behaviour.

A further advantageous use of the device is the production of a package in which the first part forms a (thermoformed, deep-drawn or injection-moulded) lid, which closes a container formed by the second part for receiving a product or item to be packaged.

On the first part there may be formed, for example, a tear-off tab to make it easier to take hold of it. With the aid of such tear-off tabs, the first part can be torn away particularly easily.

A further aspect of the invention concerns a method for torsional ultrasonic welding for joining a first part to at least one second part. In this case, the first part may at least partially comprise a film. To join the two parts, the first part is subjected to torsional ultrasonic vibrations in such a way that, after completion of the ultrasonic welding process, the first part is joined to the second part detachably to allow it to be torn away by a consumer.

When using parts with commercially available peel layers (such as for example Sure-Peel™), the first part can be subjected to a defined pressing pressure of, for example, at least 5 N/m² by the sonotrode, the pressing pressure preferably lying between 10 and 20 N/m². Depending on the type of parts, however, other pressing pressures are also conceivable. It may be particularly advantageous if the pressing pressure is kept approximately constant during the entire ultrasonic welding process or part thereof. By avoiding dynamic, oscillating loads on the material in the axial direction or perpendicularly to the parts, careful treatment of the parts to be welded can be ensured. The comparatively high pressing pressure also ensures a welding quality that satisfies even quite demanding requirements. In particular, adequately strong welded joints can be produced—while of course the desired tearing-away property is maintained—with the effect of considerably lowering the risk of unintentional detachment of the film (for example while packages are being transported).

Further individual features and advantages of the invention emerge from the following description of the exemplary embodiments and from the drawings, in which:

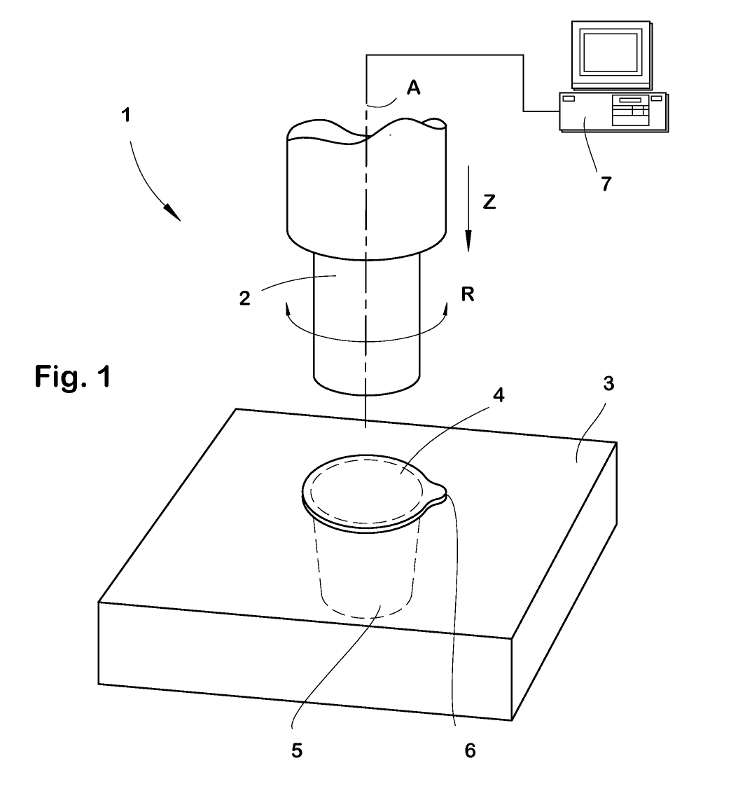

FIG. 1 shows a perspective representation of a device according to the invention for torsional ultrasonic welding.

In FIG. 1, a device for ultrasonic welding that is designated as a whole by 1 is shown in a simplified representation. The device has a sonotrode 2, which can be induced to undergo torsional ultrasonic vibrations and is arranged over an anvil 3. The torsion axis is in this case designated by A and the torsional vibration is designated by R. The anvil 3 has a shaped-part holder that is not designated specifically, in which a container 5 is held. The container may be, for example, a plastic yoghurt pot. The open upper side of the container 5 is closed by a film or a lid 4, which can be welded onto the rim of the container by subjecting it to torsional action.

The sonotrode 2 is movable up and down in a z direction by means of a lifting and lowering device (not represented here). The lifting and lowering device serves the purpose of applying a pressing force in the z direction to the film/lid 4 lying on the rim of the container. The film 4, provided for example with the peel layer Sure-Peel™, is subjected to a defined pressing pressure of at least 5 N/m² during the ultrasonic welding process by the sonotrode 2 activated by way of the control means mentioned, the pressing pressure preferably lying between 10 and 20 N/m². It is advantageous in this respect if the pressing pressure is kept approximately constant during the entire ultrasonic welding process or part thereof. The duration of a respective torsional welding process may be approximately 100-300 ms, and consequently lies approximately in the usual range of conventional ultrasonic welding with a longitudinal vibrator. For detachable welding, ultrasound in the frequency range of approximately 20 kHz-40 kHz has proven to be advantageous in tests. The vibration amplitude in this case likewise lies in the range of customary welding with longitudinal ultrasonic vibrators. The vibration amplitude may in this case advantageously be approximately 25-30 μm.

The sonotrode 2 is connected to a controller 7, with the aid of which the welding process can be controlled. The controller 7 serves for setting the method parameters for the ultrasonic welding process. Then, the controller also includes input means, by way of which the desired pressing pressure can be set. The sonotrode 2 can be controlled by the controller 7 in such a way that, after completion of the ultrasonic welding process, the film/lid 4 is joined to the container 5 detachably to allow it to be easily torn away. The device 1 is suitable in particular for processing film/lids with special coatings that are known to a person skilled in the art by the terms “peel layer” and “sealing layer”. For instance, films 2 that are known for example by the product name Sure-Peel™ (and many more besides) can be processed with the device 1. Furthermore, by way of example, lids such as those described in DE 36 13 155 A1 or DE 103 59 035 A1 could be welded onto the container with the present device.

Materials which could not previously be processed can also be combined by the torsional ultrasonic welding according to the invention. For example, it is possible with the present device to process PET layers or coated surfaces.

1. Device for ultrasonic welding for joining two parts, comprising
a device for torsional ultrasonic welding with at least one sonotrode,
an anvil,
control means for setting method parameters for an ultrasonic welding process
wherein said at least one sonotrode can be induced to undergo torsional ultrasonic vibrations, and wherein said at least one sonotrode can be activated in such a way that, after completion of the ultrasonic welding process, a first part, consisting at least partially of plastic and/or a film, is detachably connected to a second part to allow it to be torn away.

2. Method for ultrasonic welding, comprising the steps:
providing a device for torsional ultrasonic welding for connecting two parts,
providing a first part,
providing a second part,
said first part consisting at least partially of plastic and/or a film, said first part being connected to said second part detachably to allow it to be torn away.

3. Method according to claim 2, comprising the step of
providing said first part and/or said second part at least in certain portions with a peelable surface coating or intermediate layer before the ultrasonic welding process.

4. Method according to claim 3, wherein the intermediate layer is a peel layer or sealing layer.

5. Method according to claim 3, wherein the peelable surface coating or intermediate layer of said first part and/or of said second part exhibit(s) cohesive peeling properties, or at least one of the parts exhibit(s) burst-peel or break-peel properties.

6. Method according to claim 2 for producing a package, comprising the steps of
providing said first part forming a lid which closes a container formed by said second part for receiving a product or item to be packaged and
providing a tear-off tab being formed on said first part to make it easier to take hold of it.

7. Method for ultrasonic welding for detachably joining a first part to at least one second part, comprising the steps of:
providing said first part,
providing said second part, and
joining the two parts by subjecting said first part to torsional ultrasonic vibrations in such a way that, after completion of the ultrasonic welding process, said first part is joined to said second part detachably to allow it to be torn away.

8. Method according to claim 7, wherein said first part consists at least partially of plastic and/or a film.
